(19) United States
(12) Patent Application Publication
(10) Pub. No.: US 2024/0412397 A1
(43) Pub. Date: Dec. 12, 2024

(54) APP-BASED OBJECT MEASUREMENT FROM AN IMAGE

(71) Applicant: Luminus AI Holding Company, Summerville, SC (US)

(72) Inventors: Christopher Michaelis, Mount Pleasant, SC (US); Eddie Soong, Waterloo (CA); Sarit Pati Goswami, Hyderabad (IN)

(21) Appl. No.: 18/740,832

(22) Filed: Jun. 12, 2024

Related U.S. Application Data
(60) Provisional application No. 63/507,607, filed on Jun. 12, 2023.
(60) Provisional application No. 63/588,025, filed on Oct. 5, 2023.

(51) Int. Cl. G06T 7/62; G06T 7/00

(52) U.S. Cl. CPC G06T 7/62; G06T 7/0012; G06T 2207/20084; G06T 2207/30088

(57) ABSTRACT

Embodiments for a program product for determining the two-dimensional size of an object in an image are provided. The program product includes a non-transitory processor readable medium having software stored thereon. The software, when executed by one or more processing devices, is configured to provide an image of the object obtained by the camera and a range from the camera to the object. The software is also configured to determine dimensions of the object in pixels of the image and determine a pixel-to-length conversion factor for the object based on the range from camera to the object and a focal length of the camera. The software is also configured to calculate two-dimensional dimensions of the object in a unit of length, wherein the two-dimensional dimensions correspond to a plane normal to the camera and output the dimensions of the object to a user.

### RELATED APPLICATIONS

This application claims the benefit of U.S. Provisional Application No. 63/507,607, filed on Jun. 12, 2023, entitled “APP-BASED WOUND CARE SYSTEM” and the benefit of U.S. Provisional Application No. 63/588,025, filed on Oct. 5, 2023, entitled “MEASUREMENT APP”, both of which are hereby incorporated herein by reference.

### BACKGROUND

LiDAR and other distance measuring devices have been used as a part of object detection and calculation of distance to an object. For images, the depth dimension of a three-dimensional object can be determined if LiDAR data is captured along with the image. LiDAR data, however, is insufficient to measure length and width of an object in a plane normal to the sensor.

### BRIEF DESCRIPTION

Embodiments for a program product for determining the two-dimensional size of an object in an image are provided. The program product includes a non-transitory processor readable medium having software stored thereon. The software, when executed by one or more processing devices, is configured to provide an image of the object obtained by the camera and a range from the camera to the object. The software is also configured to determine dimensions of the object in pixels of the image and determine a pixel-to-length conversion factor for the object based on the range from camera to the object and a focal length of the camera. The software is also configured to calculate two-dimensional dimensions of the object in a unit of length, wherein the two-dimensional dimensions correspond to a plane normal to the camera and output the dimensions of the object to a user.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of an example system in which a measurement app as described herein can operate;

FIG. 2 is another block diagram of an example system in which a measurement app as described herein can operate;

FIG. 3 is an example login page of the measurement app;

FIG. 4 is an example page of the measurement app for receiving user selections regarding obtaining an image to be analyzed;

FIG. 5 is an example page of the measurement app showing example user inputs that can be received corresponding to an image to be analyzed;

FIG. 6 is another example page of the measurement app showing example user inputs that can be received corresponding to an image to be analyzed;

FIG. 7 is an example page of the measurement app showing example outputs provided by the measurement app indicating dimensions of one or more objects in an image;

FIG. 8 is another example page of the measurement app showing example outputs provided by the measurement app indicating an area of one or more objects in an image;

FIGS. 9A and 9B are flow charts illustrating steps of an example method of determining dimensions of an object with the measurement app;

FIG. 10 is another example page of the measurement app showing example user inputs that can be received corresponding to an image to be analyzed; and

FIG. 11 is yet another example page of the measurement app showing example user inputs that can be received corresponding to an image to be analyzed.

### DETAILED DESCRIPTION

Embodiments described herein provide for a computer-implemented system that uses a measurement app to provide precise measurements of objects automatically. The system can be used to measure a wide variety of things including dermal and epidermal conditions, industrial parts, and defects (e.g., crack or stress) in manufactured items. Dermal and epidermal conditions analyzed can include wounds, vitiligo, skin lesions, moles, rashes, etc. The disclosed systems can provide users with the ability to view, upload, and analyze images of dermatologic conditions. The disclosed systems can further allow users to track healing progress and the rate of a wound.

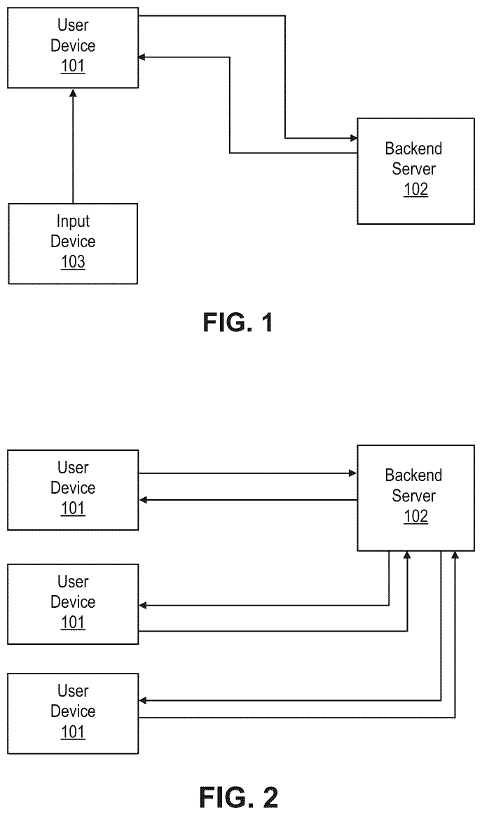

FIG. 1 is an embodiment of a system (100) that can provide precise measurements of object. The system 100 includes a plurality of user devices (101) each communicatively coupled to one or more image capture devices (103) and a backend server (102). Each user device (101) can be communicatively coupled to one or more respective image capture devices (103) and the backend server (102) over one or more networks. In an example, each user device (101) is communicatively coupled to one or more image capture devices (103) via a wired or wireless connection. In an example, each user device (101) is communicatively coupled to the backend server (102) over the Internet.

Each user device (101) is a personal computing device that allows a user (e.g., medical doctor, nurse, or technician) to process and send images to the backend server (102) as discussed in more detail below. Each user device (101) can be any appropriate computing device(s) including, but not limited to a mobile device (e.g., mobile phone, tablet, laptop, wearable device (smartwatch) or a desktop computer. Each user device (101) can run any appropriate operating system, including Android, IOS, Windows, Linux, BSD-based systems, and others. Each user device (101) has at least one processor, at least one network interface (e.g., wireless network interface), at least one storage device, one or more input-output mechanisms including but not limited to a mouse, a keyboard, a display, and/or a touch-screen display, and at least one camera. Each user device (101) includes software stored on a computer readable medium of the user device (101) that, when executed by the at least one processor, executes the methods of the user device (101) described herein.

The backend server (102) can be one or more server(s) connected together via a local area network (LAN) and/or wide area network (WAN) or a combination thereof, running an artificial neural network-based algorithm trained to detect and process images related to dermal and epidermal conditions, industrial parts, and defects (e.g., crack or stress) in manufactured items. The backend server (102) includes at least one network connection for communicatively coupling the backend server (102) to each of the user devices (101). The backend server (102) includes software stored on a computer readable medium of the backend server (102) that, when executed by the at least one processor, executes the methods of the backend server (102) described herein.

An image capture device (103) can include a camera and an interface for outputting images obtained by the camera to the user device (101). The user device (101) can receive the images from the image capture device (103) and process the images in accordance with the methods described herein.

FIG. 2 is an example of a system (200) with the user device (101) directly capturing images, receiving further input from a user, transmitting annotated images to the backend server (102), receiving processed information from the backend server (102), storing the information received, and displaying output information to the user. The process is similar to the embodiment in FIG. 1, however, instead of an external image capture device (103) being used, a camera system integrated into a user device (101) is used to capture the images. Multiple user devices 101 can communicate with a common backend server (102) in either the configuration in FIG. 1 or the configuration in FIG. 2 or a combination of FIGS. 1 and 2 where some user devices capture images directly and other user devices (101) receive information from a separate image capture device (103).

The user device (101) or image capture device (103) can also include a range sensor to capture range information corresponding to an image captured by the camera. The range sensor can be disposed proximate the camera and configured to capture range information contemporaneously with the image capture. In an example, the range sensor is a light detection and ranging (LiDAR) sensor or time-of-flight sensors).

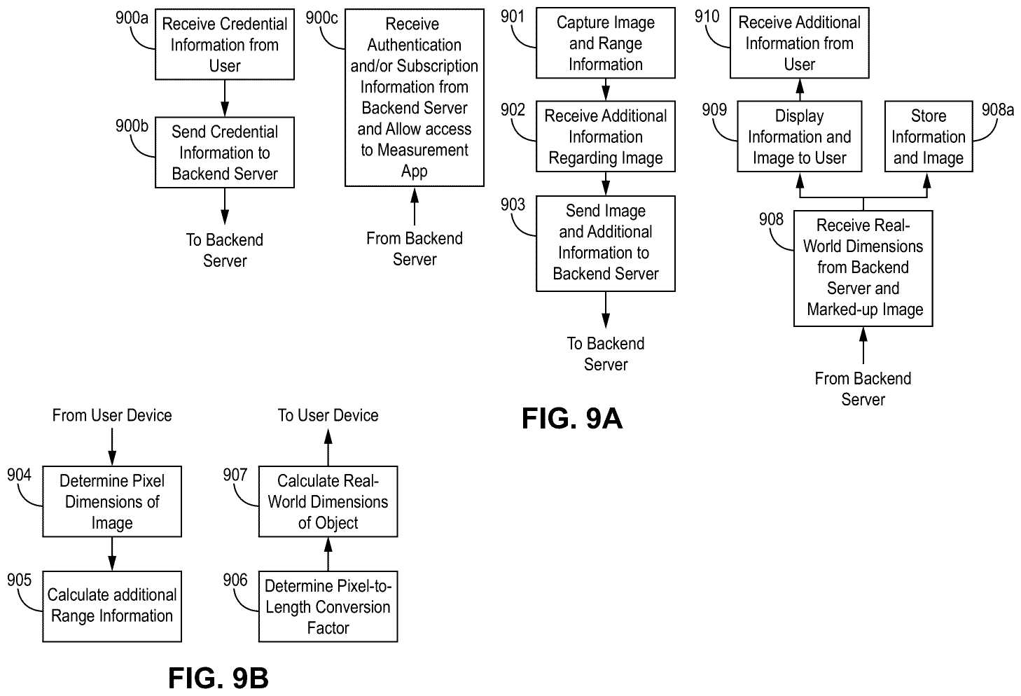

FIGS. 9A and 9B are flow charts illustrating example steps of a method of determining the two-dimensional size of an object using a measurement app in the systems of FIG. 1 or 2. FIG. 9A illustrates steps performed at a user device (101) and FIG. 9B illustrates steps performed at a backend server (102).

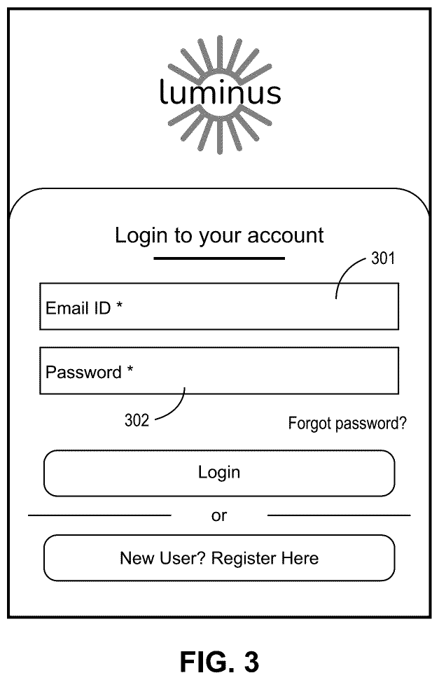

At steps 900(a)-900(c) user authentication information is received by the user device (101) to gain access to the measurement app on a user device (101) before information can be processed. FIG. 3 provides an example of a screen displayed by the user device to obtain credential information from a user, which may include an email id (301) and a password (302). In embodiments with a credential input from the user, the information obtained from the user is transmitted by the user device (101) to the backend server (102) to validate the information, and validation information is received by the user device (101) before additional input is obtained from the user. In these embodiments, multiple user devices (101) can be used with either the same credential information or with different credential information depending on the access purchased by the user. This authentication is shown at steps 90a(a)-(c) in FIG. 9, where a user device (101) receives credential information from a user, the user device (101) transmits the credential information to a backend server (102), the user device (101) receives authentication and/or subscription information back from the backend server (102), and either the user device (101) or a backend server (102) or both limit functionality based on the authentication and/or subscription information.

At step 901 an image is captured with an image capture device (103) or a user device (101). The image can be captured via an app executing on the user device (101) as described herein or otherwise provided to the app on the user device (101), for example, from an image capture device (103). In some embodiments, the images captured by a user (901, 1201) consists of multiple images. In other embodiments, the images captured by a user (901, 1201) are obtained from videographic information. In an example, a ruler or other measuring device is included by the user in the images provided via either the image capture device (103) or the user device (101) to allow for the calculation of scale. In other embodiments, LiDAR information is included within the images and a separate measuring device may not be required.

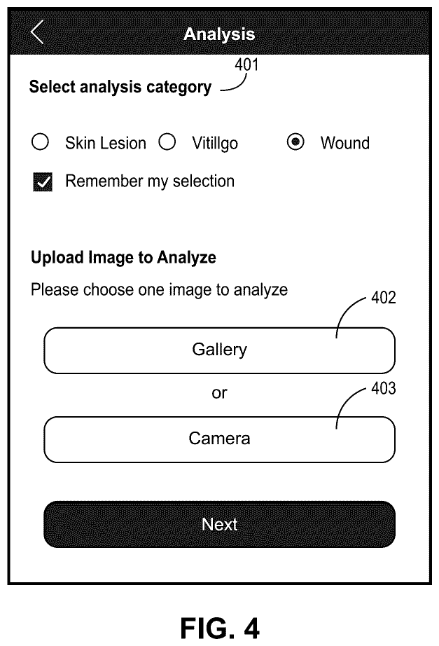

At step 902 additional information regarding the image can be received from a user. This additional information can be information relating to the axis and scope of the area including a wound, skin lesion, vitiligo, moles, rash, industrial part, or potential defect area to be analyzed. FIG. 4 shows example inputs received by the user device (101) from the user. In some embodiments of the measurement app, the images is retrieved from local storage using a gallery function (402) while in other embodiments, images is obtained via a camera function (403) using a camera attached to or part of the user device (101). Different embodiments of the measurement app can be used to analyze various items including dermal and epidermal conditions (wounds, skin lesions, vitiligo, moles, rashes), industrial parts to identify their size, or other manufactured items for potential defects. An analysis category selector (401) may be present in some embodiments of the app-based dermatologic care system to receive input from the user as to which type of condition the system analyzes.

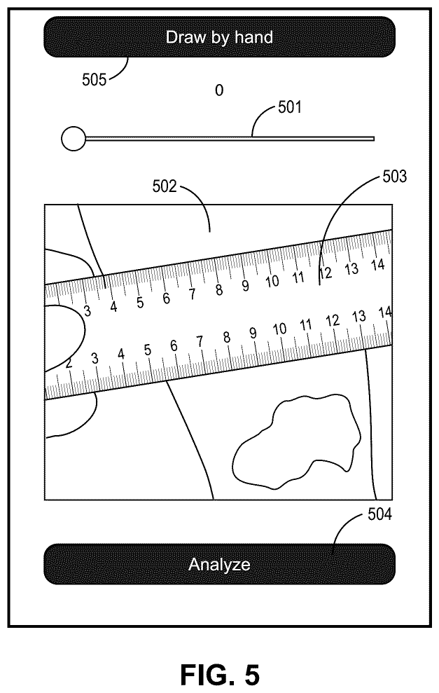

FIG. 5 shows an example of other information that can be received by the user device (101). The orientation axis input (501) allows the user device (101) to receive information about the angle at which the tissue with a wound or lesion exists within the image (502) represented by the images. A ruler or other measuring device (502) can be seen in this example, and provides the basis for an automatic detection function and/or a draw-by-hand (505) function, allowing the user device (101) to receive user input as to the scale of the image (502) along with the orientation axis input (501) information. The analyze (504) input allows the user device (101) to receive user input to transmit the images along with any additional user input received by the user device (101) to the backend server (102) for analysis. This process correlates with step 902 in FIG. 9, where a user device receives images from a user and receives additional information relating to the axis and scope of the area including a wound, skin lesion, vitiligo, moles, rash, industrial part, or potential defect area to be analyzed.

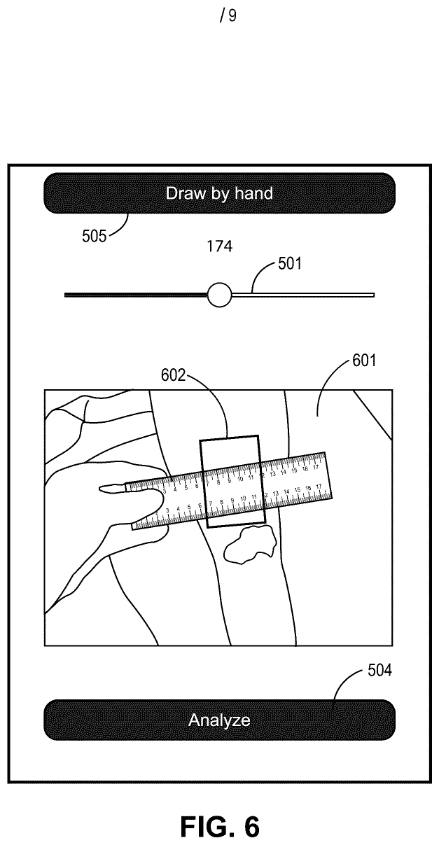

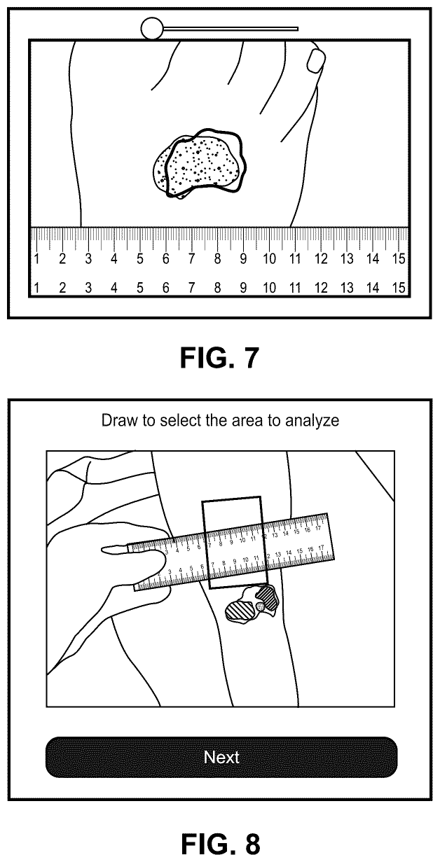

FIG. 6 shows an example of the process described above, specifically receiving axis and area information. FIGS. 7 and 8 show examples of freehand drawing input received by the user device (101). The freehand drawing input can identify an area for the measurement app and backend server (102) to analyze in the subsequent steps.

Referring back to FIG. 9, at step 903 the user device (101) transmits the image, along with additional information received from the user, to one or more backend server(s) (102).

Steps 904-907 are processing that is performed on the image by the backend server (102). At step 904 the backend server (102) determines the pixel dimensions of an object to be measured in the image. As used herein, the pixel dimensions of the object are an indication of which pixels in an image correspond to the object to be measured. The pixel dimensions can include a pixel length and width, or a pixel count that corresponds to the object to be measured. The pixel dimensions of the object can be determined in any suitable way, including via an artificial neural network-based algorithm trained to detect and process images related to identify a particular type of object within the image. In an example, the object is a dermal or epidermal condition such as wound skin lesion, vitiligo, mole or rash. In other examples, the object is an industrial part. The object can also be identified in the image using contour detection, keypoint detection, template based algorithms, edge/line detection, and/or background removal.

At step 905 the backend server (102) can normalize the range information (also referred to as depth data) using an algorithm that provides relative topographical information. This step can develop normalized range information for additional pixels of the image. This may occur within the same plane, or based on an estimate of the planes at each edge of the area for which range information is provided. In some embodiments, the methodology used for relative topographical information is one or more of the methodologies described and reviewed in Masoumian, A., Rashwan, H. A., Cristiano, J., Asif, M. S., Puig, D. (2022). Monocular depth estimation using Deep Learning: A Review. Sensors, 22(14), 5353. https://doi.org/10.3390/s22145353.

In embodiments using range information and relative topographical information, the range information provided can be used to set a scale factor that can be applied to the range information to calculate range values for regions of the images without LiDAR data provided, allowing for calculation of volume of a feature identified by the app (e.g., a wound, skin lesion, vitiligo, mole, rash, industrial part, or defect) in addition to area

At step 906 the backend server (102) determines a pixel-to-length conversion factor based on range information provided with the image. The pixel-to-length conversion factor is a conversion from the size of a pixel in the image to a real world length (e.g., centimeters) of a two-dimensional plane corresponding to an object in the image. The two-dimensional plane extends parallel to the camera, that is, normal to the optical axis of the camera.

The conversion factor depends on the distance (range) of object(s) in the image from the camera. All else being the same, the closer an object is to the camera, the smaller the distance from the camera to the object, the smaller the length a pixel in the image covers and vice-versa. For this reason, range information corresponding to the pixels of the image is obtained for the image. As discussed above, this range information can be captured contemporaneously with the image capture using a LIDAR sensor on the mobile device located proximate the camera of the mobile device. The conversion factor is also dependent upon the parameters of the image that was captured, including the focal length and resolution (e.g., number of pixels) of the camera. In an example, the focal length and the resolution of the camera can be obtained from a file (e.g., exif information file) with information corresponding to the image. The file can be provided by the mobile device or image capture device including the camera that captured the image.

In an example, the backend server (102) includes information that associates a length (e.g., centimeters) with a pixel based on the other information discussed above. This information can include a plurality of conversion line equations that can be used to determine the pixel-to-length conversion factor. The conversional line equations can be empirically created by capturing images of a defined length object at different known distances (e.g., 5 cm, 10 cm, 15 cm, up to 100 cm) from the camera and range sensor. Curve fitting techniques can be used to get a line equation (polynomial or otherwise) that associates length to pixel size based on range and the other information. This process of capturing images of a defined object at different distances and curve fitting can be done with cameras of different focal lengths to obtain respective line equations for a variety of focal lengths. The backend server (102) can reference this information to determine the pixel-to-length conversion factor for the object to be measured.

At step 907 the backend server (102) can use the pixel-to-length conversion factor to calculate dimensions of the object in the image. Any desired dimensions can be used including the area, length and width, and perimeter of the object. Optionally, the normalized range information can be used to calculate a volume, of a wound, lesion, mole, rash, or other condition of interest.

At step 908 the user device (101) receives processed information, including a marked-up version of the image, from the backend server (102) and stores and/or displays the information to the user. Step 908(a) shows how the information received by a user device (101) from one or more backend server(s) (102) may be stored for future use, for example, analyses of images over time. This can include tracking the healing of a wound or rash and/or the expansion of a lesion, mole, rash, or defect over time.

At step 909 the user device (101) displays the processed information received from one or more backend server(s) (102) to the user. At step 910 a user may provide additional inputs to the user device (101) to isolate and process additional information, such as information about a specific sub-wound or sub-lesion or the extent of subcutaneous tissue affected by a wound. These steps may consist of receiving further input from a user, transmitting annotated images to a backend server (102), receiving processed information from the backend server (102), storing the information received, and displaying output information to the user. This can result in the measurement app initiating steps 903 to 909 on an additional area of the image.

In some embodiments, prior to a user capturing images (901, 1201) a wound can be debrided, or an industrial object or crack can be cleaned, removing any dead tissue or foreign objects. This can be beneficial in assessing wound healing and, in embodiments using LiDAR, in allowing the beam to reach the full depth of the wound.

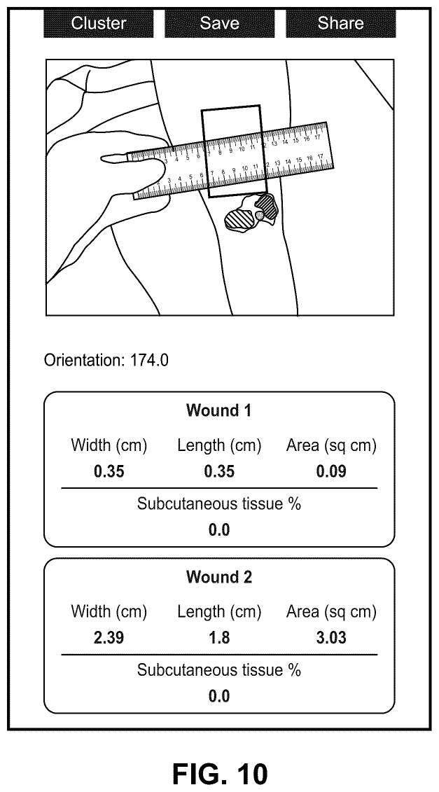

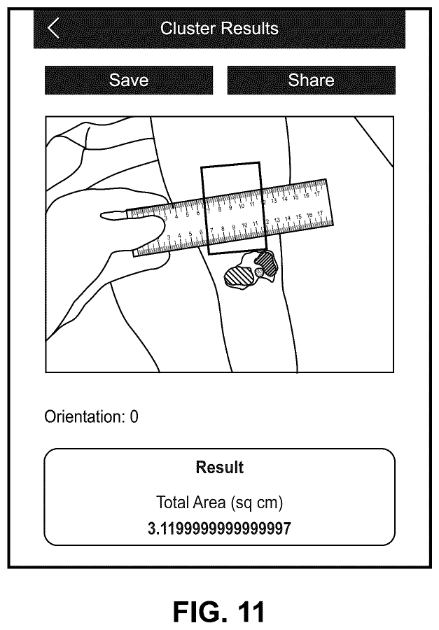

FIGS. 10 and 11 shows an example of different pages of the measurement app showing a marked-up image received and displayed by a user device (101) once a user device (101) has transmitted images and other information received from the user to one or more backend server(s) (102) and received processed information from one or more backend server(s) (102).

As referenced above the backend server (102) can be one or more server(s) connected via a local area network (LAN) or wide area network (WAN) or a combination thereof, running an artificial neural network-based algorithm trained to detect and process images related to a wound, skin lesion, vitiligo, moles, rash, industrial part, or potential defect area. In some embodiments, the backend server (102) runs an artificial neural network-based algorithm trained to detect and process information related to wounds on dermal or epidermal tissue. In other embodiments, the backend server (102) runs an artificial neural network-based algorithm trained to detect and process information related to vitiligo. In other embodiments, the backend server (102) runs an artificial neural network-based algorithm trained to detect and process information related to skin lesions. In still other embodiments, the backend server (102) runs an artificial neural network-based algorithm trained to detect and process information related to skin moles, rashes, and/or other dermatological conditions. In yet other embodiments, the backend server (102) runs an artificial neural network-based algorithm trained to detect and process information related to a particular industrial part. In still other embodiments, the backend server (102) runs an artificial neural network-based algorithm trained to detect and process information related to defects (e.g., cracks or stress) in a manufactured part. In other embodiments, the backend server (102) runs an artificial neural network-based algorithm trained to detect and process other images related to human anatomy and/or physiology. In other embodiments, an artificial neural network-based algorithm trained to detect and process images related to human anatomy and/or physiology is built on top of the U²-Net algorithm, an algorithm created by Xuebin Qin et al. for salient object detection. In other embodiments, the backend server (102) runs a combination of one or more of the prior referenced algorithms.

In embodiments where the backend server (102) runs an artificial neural network-based algorithm trained to detect and process information related to wounds on dermal or epidermal tissue, the user device (101) may additionally receive information from the backend server (102) related to stages of wound healing. Stages of wound healing may be detected either using an artificial neural network-based algorithm trained to detect and process pixel color information, in the case of images which includes color information, or trained to detect and process grayscale tone information, in the case of images which is grayscale. In some embodiments, color information is processed by the backend server (102) based on the color and morphology of a given wound. For example, some shades of red may represent a raw wound, while other shades of red may represent partial healing, and some shades of black may represent eschar. Other information such as whether adipose or bone, ligament, or tendon is exposed may be determined based on the presence of shades of yellow or white.

In some embodiments, the user device (101) may additionally receive input from the user regarding the date and time of the images or may use metadata stored in the images. This information is transmitted by the user device (101) to the backend server (102) along with the images and any other input received by the user device (101) from the user. In some embodiments, the information is processed and optionally stored by the backend server (102) to allow an artificial neural network-based analysis of the time required to heal, the progress of healing over time, and/or other time-based analyses of images provided of the same area over time. In other embodiments, the information is processed and optionally stored by the backend server (102) to allow an artificial neural network-based analysis of the stability of a skin lesion or discoloration. This may be used, for example, to predict the malignancy risk of a skin lesion over time.

In some embodiments, the artificial neural network-based algorithm(s) running on the backend server (102) is trained using manually labeled image data.

What is claimed is:

1. A program product for determining the two-dimensional size of an object in an image, the program product comprising:
a non-transitory processor readable medium having software stored thereon, the software, when executed by one or more processing devices, configured to:
provide an image of the object obtained by the camera and a range from the camera to the object;
determine dimensions of the object in pixels of the image;
determine a pixel-to-length conversion factor for the object based on the range from camera to the object and a focal length of the camera;
calculate two-dimensional dimensions of the object in a unit of length, wherein the two-dimensional dimensions correspond to a plane normal to the camera; and
output the dimensions of the object to a user.

2. The program product of claim 1, wherein the software is configured to:
capture the image of the object with a mobile device having the camera thereon;
contemporaneously with capturing the image, capture range information corresponding to the image with a range sensor of the mobile device, the range information corresponding to a distance from the camera to objects in the image, wherein the mobile device associates the range information with respective pixels of the image.

3. The program product of claim 2, wherein the software is configured to:
obtain a focal length of the camera from an information file stored on the mobile device.

4. The program product of claim 3, wherein determine a pixel-to-length conversion factor includes referencing a line equation associating a unit of length to a pixel based on focal length and range.

5. The program product of claim 1, wherein the two-dimensional dimensions comprise an area of the object.

6. The program product of claim 1, wherein determine the dimensions of the object in pixels includes using an artificial neural-network based algorithm to determine which pixels correspond to the object.

7. The program product of claim 1, wherein the artificial neural-network based algorithm is trained to identify dermal and/or epidermal conditions, such that determining the dimensions of the object in pixels determines the dimensions of visible indication of a dermal or epidermal condition.

8. A method of determining the two-dimensional size of an object in an image, the method comprising:
providing an image of the object obtained by the camera and a range from the camera to the object;
determining dimensions of the object in pixels of the image;
determining a pixel-to-length conversion factor for the object based on the range from camera to the object and a focal length of the camera;
calculating two-dimensional dimensions of the object in a unit of length, wherein the two-dimensional dimensions correspond to a plane normal to the camera; and
outputting the dimensions of the object to a user.

9. The method of claim 8, comprising:
capturing the image of the object with a mobile device having the camera thereon;
contemporaneously with capturing the image, capturing range information corresponding to the image with a range sensor of the mobile device, the range information corresponding to a distance from the camera to objects in the image, wherein the mobile device associates the range information with respective pixels of the image.

10. The method of claim 9, comprising:
obtaining a focal length of the camera from an information file stored on the mobile device.

11. The method of claim 10, wherein determining a pixel-to-length conversion factor includes referencing a line equation associating a unit of length to a pixel based on focal length and range.

12. The method of claim 8, wherein the two-dimensional dimensions comprise an area of the object.

13. The method of claim 8, wherein determining the dimensions of the object in pixels includes using an artificial neural-network based algorithm to determine which pixels correspond to the object.

14. The method of claim 8, wherein the artificial neural-network based algorithm is trained to identify dermal and/or epidermal conditions, such that determining the dimensions of the object in pixels determines the dimensions of visible indication of a dermal or epidermal condition.

15. A device comprising:
one or more processing devices;
a processor readable medium coupled to the one or more processing devices, the processor readable medium having software stored thereon, the software, when executed by one or more processing devices, configured to:
provide an image of the object obtained by the camera and a range from the camera to the object;
determine dimensions of the object in pixels of the image;
determine a pixel-to-length conversion factor for the object based on the range from camera to the object and a focal length of the camera;
calculate two-dimensional dimensions of the object in a unit of length, wherein the two-dimensional dimensions correspond to a plane normal to the camera; and
output the dimensions of the object to a user.

16. The device of claim 15, wherein the software is configured to:
capture the image of the object with a mobile device having the camera thereon;
contemporaneously with capturing the image, capture range information corresponding to the image with a range sensor of the mobile device, the range information corresponding to a distance from the camera to objects in the image, wherein the mobile device associates the range information with respective pixels of the image.

17. The device of claim 16, wherein the software is configured to:
obtain a focal length of the camera from an information file stored on the mobile device.

18. The device of claim 15, wherein determine a pixel-to-length conversion factor includes referencing a line equation associating a unit of length to a pixel based on focal length and range.

19. The device of claim 15, wherein the two-dimensional dimensions comprise an area of the object.

20. The device of claim 15, wherein determine the dimensions of the object in pixels includes using an artificial neural-network based algorithm to determine which pixels correspond to the object, wherein the artificial neural-network based algorithm is trained to identify dermal and/or epidermal conditions, such that determining the dimensions of the object in pixels determines the dimensions of visible indication of a dermal or epidermal condition.
